(19) United States
(12) Patent Application Publication
(10) Pub. No.: US 2002/0135840 A1
(43) Pub. Date: Sep. 26, 2002

(54) Connection verification and monitoring in optical wavelength multiplexed communications systems

(76) Inventors: Robert Spagnoletti, Hertford (GB); Adrian Sparks, Ongar (GB); Duncan Forbes, Bishops Stortford (GB)

Correspondence Address: Lee, Mann, Smith, McWilliams, Sweeney & Ohlson, P.O. Box 2786, Chicago, IL, 60690-2786, US

(21) Appl. No.: 09/815,860

(22) Filed: Mar. 23, 2001

(51) Int. Cl. H04J 14/02

(52) U.S. Cl. 359/128; 359/124

(57) ABSTRACT

A wavelength demultiplexer for demultiplexing optical signals carrying data, is also used to route a separate monitoring signal on to any of the demultiplexed output paths, by changing the wavelength of the monitoring signal. This enables optical paths through a switching arrangement to be verified or tested. A multiplexer at the output of the switching arrangement may be used to detect which of the output paths of the switching element has the monitoring signal. This saves the need for individual couplers to couple a monitoring signal on to each of the inputs, and off each of the outputs of the switching element. The saving in terms of component count, cost, and reduced size increases as the number of channels increases.

### FIELD OF THE INVENTION

The invention relates to switching arrangements for optical communications networks using wavelength division multiplexing, to nodes for such networks, to optical demultiplexers for adding monitoring signals, to optical multiplexers having monitoring signal outputs, to wavelength adding nodes, to wavelength dropping nodes, to test apparatus for such switching arrangements to methods of verifying connectivity, to network management systems for controlling monitoring of optical paths, and to methods of using a demultiplexer for routing a monitoring signal.

### BACKGROUND TO THE INVENTION

Various ways are known for testing and verifying connectivity in a communications network. Testing or verifying connectivity involves ensuring that data from one node in the network is switched or routed correctly by one or more nodes in the network, to reach its intended destination node. Such testing or verification may be carried out on an end to end basis, or at each individual node for example. It is known to use network layer protocols such as TCP/IP to check connectivity, by having the destination node send acknowledgement messages or packets, to confirm data has arrived, or request retransmission if some data has not arrived at the desired destination node. At the physical data transfer level, it is known to insert path trace bites to ensure a frame of data has been routed correctly. However, such methods involve demultiplexing the data stream, to access such frame information, which may be carried out only at a terminal at the end of the path through the network. Particularly for high data rate optical networks, such as those operating at the >1G/s, it is prohibitively expensive to provide such demultiplexing at intermediate nodes.

As optical networks, and particularly photonic networks (where signals are switched and processed in the optical domain) become more widespread and more complex, the need for connection verification, also known as path tracing, at an optical level becomes greater. One way of achieving this without the disadvantages of accessing digital frame data, is shown in U.S. Pat. No. 6,005,695 (Roberts). This shows a verification system for verifying that a switch has correctly switched optical signals. It involves tapping an input optical signal, and tapping an optical output signal. These signals are compared by pattern matching without the need for demultiplexing the digital data stream. To make the pattern matching circuitry relatively simple, a low frequency dither signal may be added to the input optical signal, without effecting the data traffic, and, provided each input signal has a distinctive dither, the pattern matching may be carried out on this low frequency dither.

It is also known to add a separate wavelength outside the signal band using a wavelength selective coupler on each input port. This wavelength can then be detected at the output ports, and thus used to verify that the correct input has been coupled to a given output.

### SUMMARY OF THE INVENTION

It is an object of the invention to provide improved apparatus, systems and methods. According to a first aspect of the invention there is provided a switching arrangement for optical communications networks, the arrangement having a wavelength demultiplexer for demultiplexing wavelength multiplexed input data signals, a switching element for defining optical paths for the demultiplexed data signals, a multiplexer for wavelength multiplexing the demultiplexed data signals output from the switching element, and test apparatus for sending a monitoring signal of a selected wavelength through the switching element, using the demultiplexer or the multiplexer to route the monitoring signal along a desired one of the optical paths through the switching element, according to the wavelength of the monitoring signal, the test apparatus further arranged to detect the monitoring signal after it has passed along the desired optical path.

Using the multiplexer or the demultiplexer for routing the monitoring signal can save the need for individual couplers to couple a monitor signal on or off each of the optical paths of the switching element. The saving in terms of component count and cost of manufacture, as well as reduced size, can be very significant, and tends to increase as the number of wavelength demultiplexed channels in the system increases. The monitoring signal can be used not only for verifying connectivity, of an optical path, but also for measuring optical parameters such as path loss, cross-talk and for a feedback signal to control parameters such as optical gain/attenuation, or mirror alignment. Results of monitoring could even be used for triggering protection switching either within the switching element, or on a wider scale.

The same demultiplexer or multiplexer used for the data signals, can be used for routing the monitoring signal, simply by selecting or changing the wavelength of the monitor signal. These advantages can be achieved at either the output of the switching element or the input, or both.

In one preferred option, the switching arrangement is arranged to route the monitoring signal along the desired one of the optical paths at the same time as the demultiplexed data signals are passing through the switching element. This enables the monitoring signal to be used not only during set up but during live operation or test operation of the switching arrangement.

According to one preferred option, the test apparatus is arranged to select the wavelength of the monitoring signal to be offset from a wavelength of the demultiplexed data signal on the desired optical path. This is a convenient way of allowing the monitoring signal to share the same optical path at the same time as the demultiplexed data signal without mutual interference.

Another preferred option involves the demultiplexer having a monitoring signal path spatially separated from an input path for the multiplexed data signal. This facilitates avoiding mutual interference between the multiplexed data signal and the monitoring signal.

Another preferred option involves the demultiplexer further having a shuffle property that for a given wavelength of an input signal, a spatial shift to a different input path for that signal can cause a corresponding spatial shift of an output path of that signal, the shuffle property being used to enable the demultiplexer to route the monitoring signal between the desired optical path and the spatially separated monitoring signal path, and to route simultaneously the demultiplexed data signal onto the same desired optical path from the input path for the multiplexed data signal. This shuffle property makes it easier to achieve this result than in devices using for example dielectric films to select wavelengths. In such dielectric devices, the output port associated with a given wavelength does not change as the spatial position of the input changes.

In another preferred option the demultiplexer is an arrayed waveguide device. This is convenient as it is a well known, well proven, widely available device.

Corresponding advantages to those set out above arise where the multiplexer has a monitoring signal path spatially separated from an output path for the multiplexed data signal. Corresponding advantages also arise where the multiplexer further has a shuffle property that for a given wavelength of an input signal, a spatial shift to a different input path for that signal can cause a corresponding spatial shift of an output path of that signal. Corresponding advantages also arise when the multiplexer is an arrayed waveguide device.

The switching arrangement may be arranged to use both the demultiplexer and the multiplexer for routing the monitoring signal, to gain the advantages set out above for each of these devices.

If the test apparatus is arranged to select the wavelength of the monitoring signal within a band of wavelengths used by the multiplexed data signal, better use of bandwidth can be achieved, which becomes more important as efforts are made to get as much data capacity as possible by using as many wavelengths as possible. It also enables the monitoring signal to use wavelengths close to those used by the data traffic, which may give better monitoring of any parameters which may be wavelength sensitive.

The test apparatus may have apparatus for controlling the wavelength of the monitoring signal to control which of the optical paths is being monitored. This may involve a tuneable source for outputting a monitoring signal onto different ones of the optical paths by controlling the wavelength of the monitoring signal. Such a tunable source enables more efficient use of optical power sent in the monitoring signal compared to a solution involving selective filtering for example, especially where large numbers of wavelengths are involved. It is also relatively easy to control wavelength accurately to select the desired optical path.

The test apparatus may be arranged to send a plurality of monitoring signals of different wavelengths simultaneously, and have a tuneable receiver for distinguishing between the monitoring signals. This may be done as an alternative to using a tunable transmitter, or the two techniques may be combined. Using a tuneable receiver may bring the advantage of concentrating the control circuitry at the receiver, which may be particularly useful if the receiver is remotely located from the sending side of the test apparatus.

The test apparatus may have circuitry for determining which monitoring signal wavelength to use to cause the monitoring signal to pass along the desired optical path. This may be a predetermined relationship, or dynamically determined relationship, and may use a look up table for example.

The test apparatus may have circuitry for controlling the wavelength of the monitoring signal, coupled to circuitry for detecting the monitoring signal, the test apparatus being arranged to determine which wavelengths have been detected. This coupling enables many different wavelengths and optical paths to be used with less risk of confusing which ones have been successfully monitored. This may be particularly important when verifying connectivity or testing for cross-talk.

The test apparatus may be arranged to send the monitoring signal on one optical path, and detect from another optical path. This is useful to detect cross-talk, or to detect the cause and effects of a misconnection.

The switching arrangement may involve the demultiplexers having output paths and the multiplexers having input paths, each for use by demultiplexed data signals of a corresponding wavelength, the switching element having a number of wavelength planes, each plane arranged to switch the demultiplexed data signals of a single wavelength between the input paths and output paths corresponding to that wavelength. This is one common configuration of a switching element, for which the monitoring scheme set out above is well suited. It may or may not be combined with wavelength transfer apparatus for transferring a data stream from one wavelength to another.

The test apparatus may have optical path parameter measurement circuitry, for measuring a parameter of the optical path passed by the detected monitoring signal, and optical path parameter control circuitry, for controlling the optical path parameter according to an output of the measurement circuitry. This enables the monitoring signal to be used for more than just connectivity verification, and may facilitate mirror alignment, gain control, polarisation mode dispersion compensation, selection of switchable regeneration, and even control of chromatic dispersion (if the wavelength sensitivity is not too great, or if the monitoring signal uses the same wavelength as the demultiplexed data signals.

Another aspect of the invention provides a node for an optical network having the switching arrangement set out above, and optical amplifiers for transmitting the multiplexed data signal to other nodes. The invention may have a notable impact on the design of an entire node, since for example the reduced component count may enable a reduced footprint, or more data capacity or more wavelengths to be accommodated in the same footprint.

Another aspect of the invention provides a wavelength adding node for a wavelength division multiplexed optical network, the node having the switching arrangement set out above, the switching element having at least one wavelength add input path not passing through the demultiplexer, the test apparatus being coupled to send and detect monitoring signals along the add input path. This is another significant application of switching elements in optical networks, to enable dynamic selection of which wavelengths to add, and the advantages set out above apply at least to the multiplexed sides of such nodes.

Another aspect of the invention provides a wavelength dropping node for a wavelength division multiplexed optical network, the node having the switching arrangement set out above, the switching element having at least one wavelength drop output path not passing through the multiplexer, the test apparatus being coupled to send and detect monitoring signals along the drop output path. Again this is another significant application of switching elements in optical networks, to enable selection of which wavelengths to drop, and the advantages set out above apply at least to the multiplexed sides of such nodes.

Such adding or dropping nodes can of course include appropriate ones of the optional features set out above, and achieve corresponding advantages, as would be apparent to a skilled person.

Another aspect of the invention provides demultiplexing apparatus having a wavelength demultiplexer for demultiplexing optical wavelength multiplexed input data signals onto a number of output optical paths, and a tunable source, for outputting at a selected optical wavelength a monitoring signal to the demultiplexer, on a separate path from the multiplexed input data signals, the demultiplexer being arranged to route the monitoring signal onto a selected one of the output optical paths according to the wavelength of the monitoring signal, for detection downstream along the optical paths. This is one notable application of the invention which does not necessarily use a switching element. The detection may be located remotely from the demultiplexer.

Another aspect of the invention provides multiplexing apparatus having a wavelength multiplexer for optical wavelength multiplexing a number of input data signals on a number of input optical paths, and a receiver, for receiving at a selected optical wavelength a monitoring signal, the multiplexer being arranged to route the monitoring signal to the receiver, from a selected one of the output optical paths according to the wavelength of the monitoring signal, and on a separate path to the multiplexed output data signals. This is another notable application of the invention which does not necessarily use a switching element. The source of the monitoring signal may be located remotely from the multiplexer.

Another aspect of the invention provides test apparatus for a switching arrangement for optical communications networks, the arrangement having a wavelength demultiplexer for demultiplexing wavelength multiplexed input data signals, a switching element for defining optical paths for the demultiplexed data signals, and a multiplexer for wavelength multiplexing the demultiplexed data signals output from the switching element, the test apparatus having circuitry for sending a monitoring signal of a selected wavelength through the switching element, using the demultiplexer or the multiplexer to route the monitoring signal along a desired one of the optical paths through the switching element, according to the wavelength of the monitoring signal, and circuitry arranged to detect the monitoring signal after it has passed along the desired optical path.

The test apparatus may be a significant part of the value of a node, and may be supplied or upgraded separately.

The test apparatus may have optical path parameter measurement circuitry, for measuring a parameter of the optical path passed by the detected monitoring signal.

Another aspect of the invention provides a network management system for use with nodes of an optical communications network, at least one of the nodes having a switching arrangement as set out above, the network management system having software for indicating to the test apparatus of the switching arrangement which optical path to monitor, and software for receiving monitoring results from the test apparatus. The network management system can be made more effective by feeding it information on individual optical paths within the switching arrangement for a wavelength division multiplexed system, and allowing it to request such information, since there are likely to be network level impacts of faults or performance degradations on individual optical paths, even if there is local fast control of protection switching. The network management system is often a critical and valuable component, which again may be sold or upgraded separately from other parts of the system.

Another aspect of the invention provides a method of using a demultiplexer for routing a monitoring signal, the demultiplexer being arranged to demultiplex optical wavelength multiplexed input data signals onto a number of output optical paths, the demultiplexer having a separate input for a monitoring signal, the method comprising the step of inputting the monitoring signal at a wavelength selected such that the demultiplexer routes the monitoring signal onto a desired one of the output paths according to the wavelength of the monitoring signal, for detection downstream along the optical paths.

Any of the optional features may be combined with any of the aspects of the invention as appropriate, as would be apparent to those skilled in the art. Other advantages to those indicated above may be apparent to those skilled in the art, particularly relative to other prior art not known to the inventors.

### BRIEF DESCRIPTION OF THE DRAWINGS

In order to show how the invention may be carried into effect, embodiments of the invention are now described below by way of example only and with reference to the accompanying figures in which:

FIG. 1 shows an optical network including a number of switching arrangements according to a first embodiment of the invention,

FIG. 2 shows in schematic form features of one possible implementation of the switching arrangement shown in FIG. 1,

FIG. 3 shows in schematic form features of one possible implementation of the demultiplexer shown in FIG. 2,

FIG. 4 shows in schematic form features of one possible implementation of the test control part shown in FIG. 2,

FIG. 5 shows in schematic form an alternative implementation of the test control part,

FIG. 6 shows one possible implementation of the multiplexer shown in FIG. 2, for use with the test control embodiment of FIG. 5,

FIG. 7 shows an alternative embodiment of the switching arrangement shown in FIG. 2, with the direction of the monitoring signals being opposed to the direction of the data signals,

FIG. 8 shows an alternative embodiment of a switching arrangement, arranged for adding or dropping signals,

FIG. 9 shows a further embodiment of the invention having a tuneable source and a demultiplexer, without necessarily including a switching arrangement,

FIG. 10 shows a further alternative implementation of the switching arrangement, in which the monitoring signals enter the demultiplexer and leave the multiplexer on the same path as the data signals,

FIG. 11 shows a switch set up controller according to a further embodiment of the invention.

### DETAILED DESCRIPTION OF INVENTION

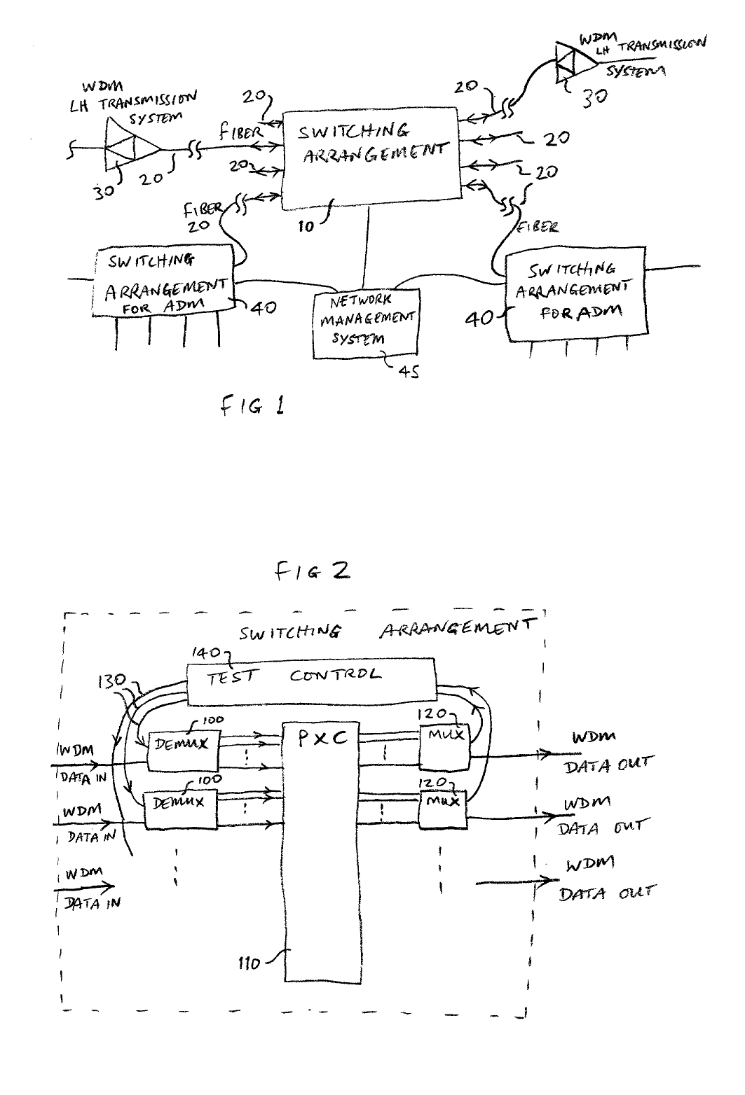

FIG. 1 shows a high level of a communications network including 10 according to a first embodiment of the invention. The switching arrangement is coupled to a number of optical fibers 20 for carrying optical signals wavelength division multiplexed together for carrying data traffic.

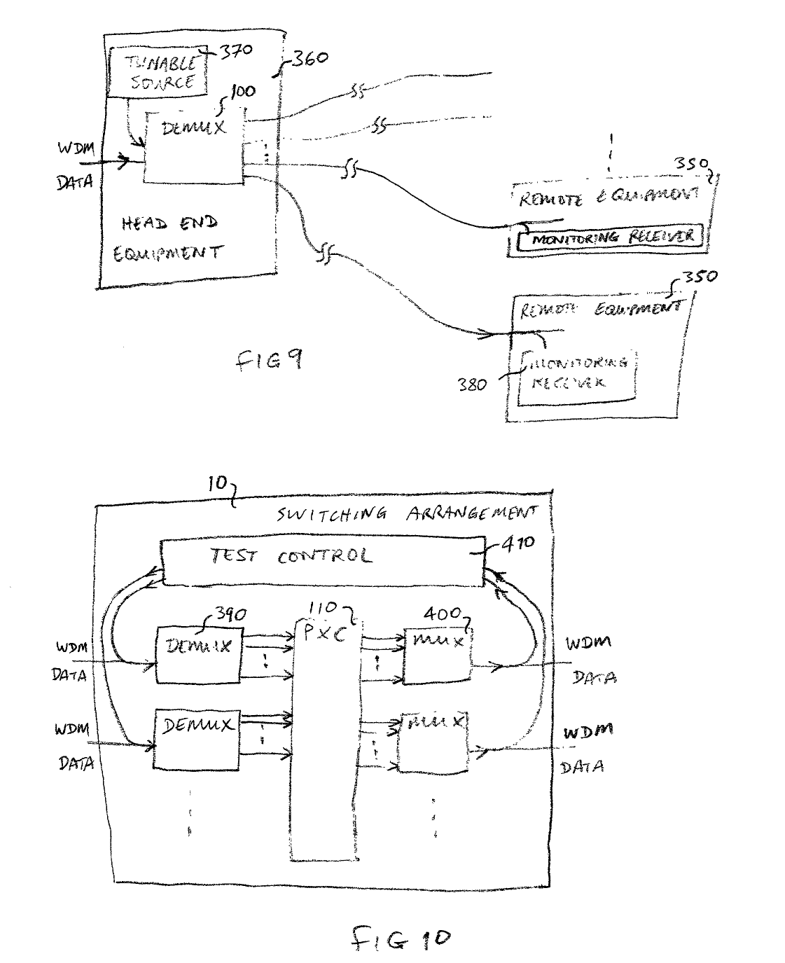

Four fibers are shown on each side of the switching arrangement, though there may be many more, depending on the desire to configuration of the network. In the example shown, some of the fibers are for long haul traffic, coupled to amplifiers for a WDM long haul transmission system 30. One amplifier is shown, on each side, though typically there could be many more. Some of the fibers connected to the switching arrangement (10) may be used for shorter haul transmission, typically arranged in interconnected ring networks, and coupled to add/drop multiplexers 40. These may be implemented by a switching arrangement for ADM (add/drop multiplexing) as will be described in more detail below with reference to FIG. 8.

The network of FIG. 1 is just one of many possible configurations in which the switching arrangement can be used, as would be apparent to a skilled person. As long haul and short haul WDM (wavelength division multiplexed) systems are well known, there is no need to describe them here in more detail. A network management system 45 is also illustrated, which is typically located remotely, and coupled to each node by a low data rate network such as an IP (Internet Protocol) network. Such management systems are well known and can be adapted to communicate with the switching arrangement following well established principles.

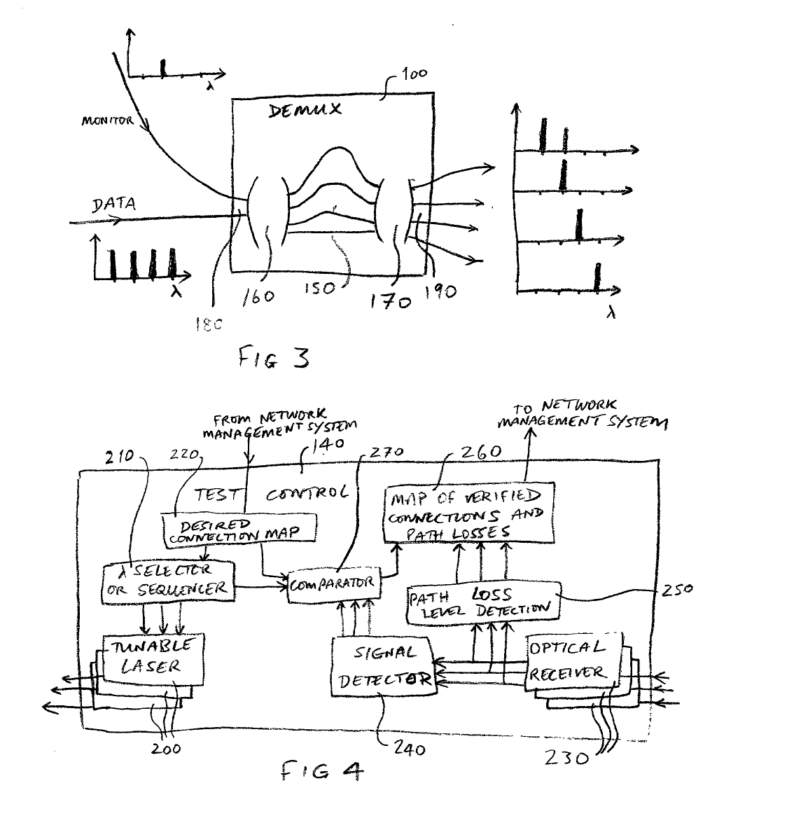

FIG. 2, Switching Arrangement

FIG. 2 shows one possible implementation of the switching arrangement 10 of FIG. 1. It is illustrated with fibers carrying WDM input data entering on the left hand side, and corresponding output fibers on the right hand side, for convenience and clarity of illustration, in practice the input and output fibers for each route may be terminated on the same or nearby cards in a rack, following conventional physical design principles.

The input fibers carrying data traffic on numerous channels wavelength division multiplexed together is fed to a wavelength division demultiplexer 100. Following demultiplexing, individual channels, or groups of channels are fed on physically separate optical paths to the PXC (Photonic Cross-Connect), 110, for routing to a desired one of the output fibers, via multiplexers 120.

The number of demultiplexers and multiplexers will depend on the number of input and output fibers respectively. Some or all of the demultiplexers may have a monitoring signal input 130, from a test control function 140. The monitoring signals are fed through the demultiplexer, the PXC and one of the multiplexers, before being processed by the test control function. As will be explained in more detail below, these monitoring signals may be used for verifying connectivity across the various elements of the switching arrangement, may be used for monitoring optical path characteristics through these elements, and may be used as feedback signals to enable the optical path characteristics to be controlled or optimised automatically.

Various configurations are possible for the test control function, as will be described below, particularly with reference to FIGS. 4, 5 and 11. The PXC is one example of how the switching element can be implemented. Various alternatives are possible, either maintaining the signals as optical signals, or conceivably involving optical regeneration, or electrical regeneration. In the latter case, the monitoring signal may need to be picked off at the point of electrical regeneration, unless the monitoring signal is only present when the data signal is not present on the same path. Normally an electrical regenerator would be unable to output multiple wavelengths.

The demultiplexer and multiplexer may be implemented in a variety of forms. Arrayed waveguides (AWG) devices will be described further below for this purpose, though alternatives are conceivable based on refractive and diffractive effects.

FIG. 3, AWG Demultiplexer

The demultiplexer shown in FIG. 3 is a widely available device, with no particular alteration needed, to achieve the advantages of the invention. It operates to separate onto different optical output paths depending on the wavelength of the signal on the input path. There may be many input paths and many output paths, currently devices can provide 16 or 40 paths.

Any type of demultiplexer can achieve this basic function, and route a monitoring signal onto any one of the outputs, depending on the wavelength of the monitoring signal. To achieve the additional advantage of being able to do this without interrupting data traffic, either requires that the monitoring signal be somehow orthogonal to the data signal or requires a demultiplexer which has the flowing property. It has a monitoring input physically separated from the data input, which results in the monitoring signal being “shuffled” to a different output compared to the output of the same wavelength when input on the data input. This is most conveniently achieved using arrayed waveguide gratings, and therefore these will be described further here.

The basic components of the device of FIG. 3 are an optical waveguide grating indicated generally at 150, and two radiative stars indicated schematically at 160 and 170. Input and output optical waveguides are also provided, illustrated at 180, 190. Monochromatic light launched into one of the input waveguides spreads out in the radiative star 160. It illuminates the input ends of all the waveguides of the grating 150. At the far end of the grating, the field components of the light interfere coherently in the far field to produce a single bright spot at the far side of radiative star 170. Depending on the wavelength of the light, the phase relationship of these field components determined the position of the bright spot. Provided the mode size of the output waveguides is well matched with the size of the bright spot, then efficient coupling occurs.

The operation of the demultiplexer can be explained with reference to the signal spectrum graphs shown in FIG. 3 for the inputs and outputs. The monitoring signal, on the monitoring path in this example is shown on the second of the four channels. Data inputs are shown as existing in all four wavelength channels. The resulting outputs are shown at the right hand side of FIG. 3. The top or first output has the monitor signal on the second channel, and has the data signal which was on the first channel at the input. The second output has no monitor signal, but has the data signal that was on the second channel of the data input. The third output has the data signal which was on the third channel at the input, and so on.

The monitoring signal can be fed to any one of the outputs simply by changing the wavelength of the monitor signal at the input to the demultiplexer. This can be achieved by a tuneable source for example.

Exactly the same device may be used for the multiplexer 120, but arranged with the optical paths being reversed, so that demultiplexed signals are fed in at one side, and at the other side, a multiplexed data signal is output, from one port, and a monitor signal is output from the other output port.

An alternative, not illustrated, would be to incorporate individual monitor taps on each of the input to the multiplexer, and thereby determine whether the monitor signal has been switched by the PXC to the correct output. However, this would involve more components, which becomes more and more significant as the number of wavelengths in the system increases into the tens or hundreds.

By using an AWG type multiplexer for selecting the monitor signal, the component count can be kept low. Verification is achieved because if the monitor signal is switched by the PXC to an incorrect one of the inputs of the multiplexer without changing the wavelength of the monitor signal, then the multiplexer will not route that monitor signal to the monitor output. This absence of signal can be detected and processed. This will now be described in more detail with reference to FIG. 4.

FIG. 4 Test Control

FIG. 4 shows one possible implementation of the test control part of FIG. 2. First, the monitor signals are generated and output to the demultiplexers. Tuneable lasers 200 are shown, though obviously a single tuneable laser or source could be used and its output switched to each of the demultiplexers. The wavelength of the tuneable laser will be controlled by a selector or sequencer 210. This can be arranged to cycle through all the possible wavelengths, or only one or more desired wavelengths. The desired wavelengths may be chosen from a stored map of desired connections, 220. This is optional, and if used, could be located remotely within the network management system if desired. The network management system has an appropriate interface for communicating with the test control part of the switching arrangement. It may include a software program for indicating to the test control part which are the desired connections, and which optical paths to monitor or to set up. The network management system may also have programs for receiving the monitoring results and taking appropriate action such as flagging and detecting causes and consequences of faults or performance degradations.

The test control part also includes optical receivers 230 for taking in the optical monitoring signal outputs from the multiplexers. These can be relatively inexpensive, because they do not need to be wavelength selective, to be able to distinguish between the different wavelength channels. This arises because the multiplexers are inherently wavelength selective, i.e. the monitoring signal must be on the right physical channel and be the right wavelength, to be passed through to the monitoring output.

The optical receiver may output an analogue electrical signal converted from the optical signal. In a simple example this could represent the optical power level. This could make use of a simple photodiode. By measuring the power level, rather than only connectivity, more useful information can be obtained. Optical parameters may be measured providing they are not heavily dependent on wavelength. For example by varying the input polarisation of the monitoring signal, polarisation dependent loss of the optical path could be measured at the monitoring signal receiver. Multiple optical receivers are shown, one for each multiplexer, though of course the monitoring signals could be multiplexed into a single optical receiver as desired.

The outputs of the optical receivers may be fed to signal detector functions 240, for thresholding for example, for the purpose of connection verification. They also may be fed to path loss level detection functions 250, for producing a digital value of path loss, for further processing, such as storage in a map of connection path losses, 260. Also, such loss level information may be used as feedback to adjust the gain or attenuation of active elements in the optical path, either within the switching arrangement, or elsewhere, if the path loss is not within acceptable limits (not illustrated).

The test control may also include a comparator 270 for comparing the result of the signal detection, with an indication from the desired connection map that the PXC is intended to pass the given wavelength to a given one of the multiplexers, together with an indication from the selector or sequencer, that the monitoring signal is being sent. The output of the comparator is an indication that a given desired connection is verified, or otherwise. This output may be fed to the map of verified connections. This map may be fed to the remote network management system, or the network management system may hold the map itself.

If the monitoring signal is sent along one optical path, and the receiver set up to detect signals on a different one of the optical paths, then optical cross-talk between these paths can be measured. In particular this is useful for measuring cross-talk between adjacent channels in the multiplexer and demultiplexer.

FIG. 5 Alternative Test Control Implementation

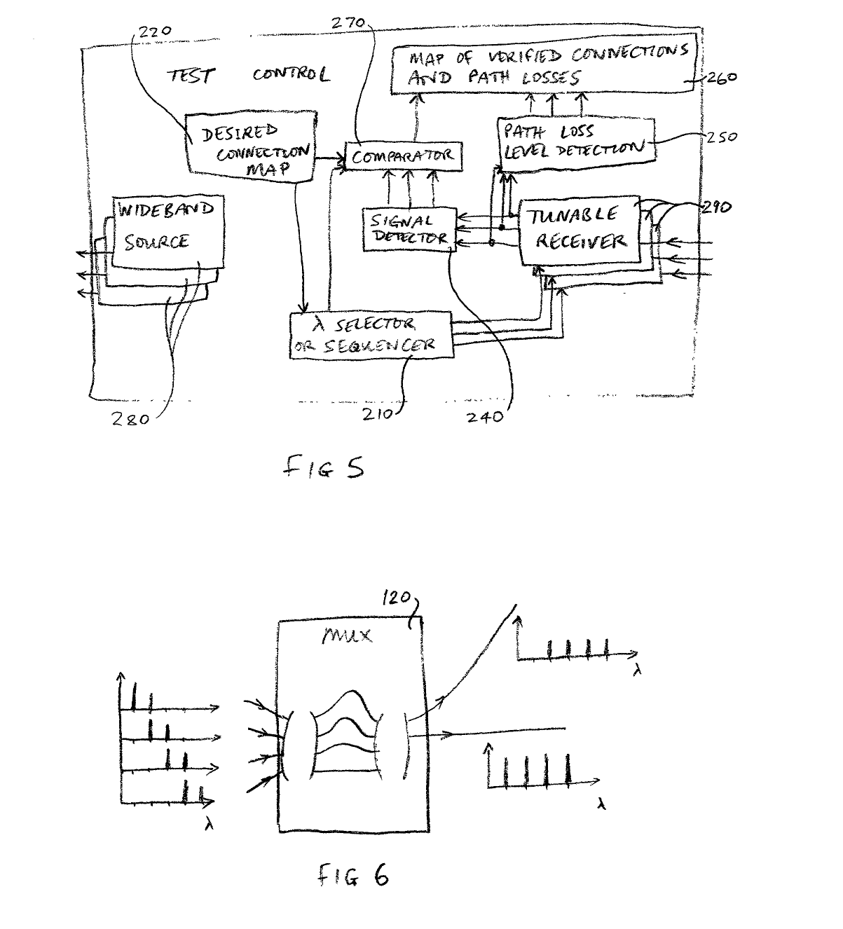

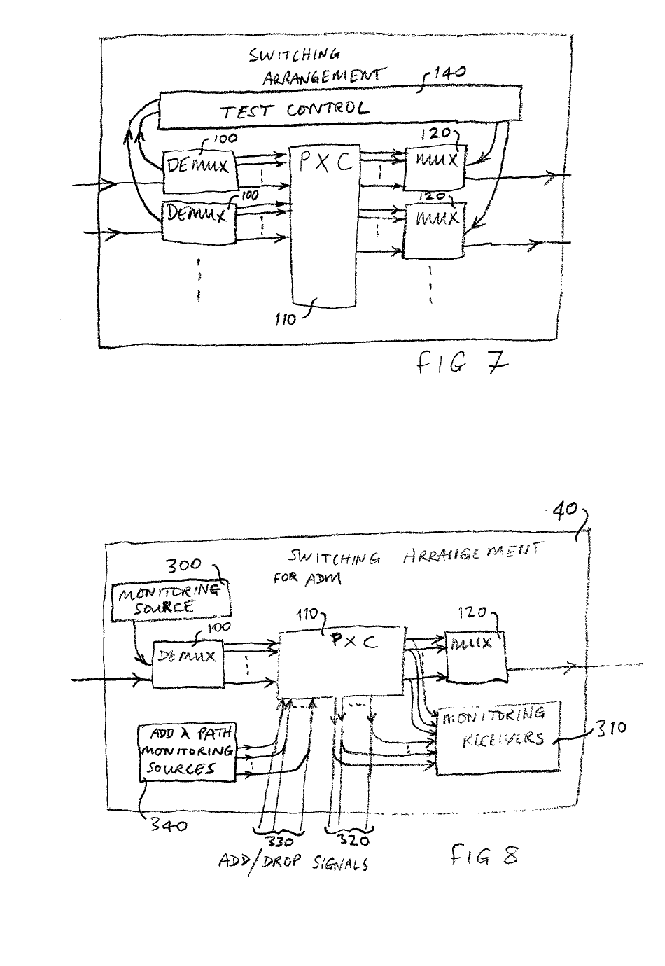

FIG. 5 shows an alternative implementation based on the use of a non tuneable source, but a tuneable receiver. In this case, the monitoring signal output from the test control covers all the wavelength channels. This may be implemented simply as a wide band source 280, which may simply output white light. A tuneable receiver 290 is provided for each of the monitoring signals from the multiplexers. The white noise monitoring signal fed to the demultiplexers, will be split, such that different wavelength portions are passed on to corresponding physical outputs of the demultiplexer. These will be switched by the PXC to arrive at the inputs of the multiplexers. Taking the simplest example where the PXC routes all the signals from one demultiplexer through to the same multiplexer, the resulting monitoring output of that multiplexer would show the monitoring signals spread across all the channels. Accordingly, to be able to verify individual paths through the PXC, the tuneable receiver is used to detect that there is a signal on each of the wavelength channels in turn individually. FIG. 6 illustrates the wavelength spectra of each of the inputs and outputs of the multiplexer for this example. The tuneable receiver may be controlled by a selector or sequencer 210 exactly as the tuneable source of FIG. 4 would need to be controlled. The remaining features of the test control part are the same as those shown in FIG. 4, and corresponding reference numerals have been used throughout.

FIG. 7, Embodiment with Monitoring Signal in Reverse Direction FIG. 7 shows an alternative embodiment in which the direction of the monitoring signal is opposed to the direction of the data signals. This is possible if the demultiplexer, the PXC and multiplexer are reversible, which is the case for AWG type devices, and for some types of optical switching technology such as moveable mirror type devices. Accordingly, this implementation can be achieved using the same elements as shown in FIG. 2, and therefore corresponding reference numerals have been used.

FIG. 8, Add/Drop Multiplexer Embodiment

FIG. 8 shows one possible implementation of the switching arrangement for ADM shown in FIG. 1.

In this case, because the switching arrangement is used for adding or dropping wavelengths, or groups of wavelengths, the dropped or added wavelengths or group of wavelengths may not pass through a demultiplexer or a multiplexer respectively. The switching element, exemplified by the PXC 110, is controlled to add selected wavelengths in to the multiplexed WDM signal, or to drop selected wavelengths, and to pass the remaining wavelengths through for onward transmission along the main path.

If it is desired to be able to reconfigure which wavelengths are dropped or added, which is likely to be more and more useful, then a photonic cross-connect is a favourable option for achieving this. A photonic cross connect and other ways of achieving it will involve wavelength demultiplexing at the input, and wavelength multiplexing at the output. Accordingly, even if the added or dropped wavelengths are not multiplexed or demultiplexed, there is still a benefit in applying embodiments of the invention, to this arrangement, to enable testing of the optical paths to be achieved more easily, by reducing the component count at the WDM interfaces.

As shown in FIG. 8, a monitoring source 300 is provided to generate a monitoring signal for input to the demultiplexer 100. Monitoring receiver 310 are shown coupled to the outputs of the PXC, for detecting the monitoring signal. The received signals may be processed in a similar manner to that described above for other embodiments. Individual taps are shown for each of the dropped optical wavelength paths 320, as there is no data multiplexer in this case. To reduce the number of receivers, these monitoring signal paths could be multiplexed together. Individual optical taps off each of the inputs to the multiplexer 120 are also shown, for input to the monitoring receivers 310. If desired, the multiplexer 120 could be used as shown in FIG. 6, to provide a single monitoring signal path for monitoring the optical paths input to the multiplexer 120.

A shown in FIG. 8, monitoring signals can be fed through the demultiplexer and the PXC, to test all the optical paths used for dropping signals or passing them through without dropping. This can be achieved by either varying the wavelength of the monitoring source 300, or varying the wavelength sensitivity of the monitoring receivers, in the manner described above for other embodiments.

Of course it is desirable to test the optical paths for signals being added, and this can be achieved in a corresponding fashion. Monitoring sources could be provided for each individual one of the optical paths 330 for adding wavelengths, as they are input to the PXC. This is illustrated by the added wavelength monitoring sources 340. As these added wavelength path monitoring sources 340 are not associated with a demultiplexer, they could be provided up stream, remotely from the PXC, if desired. This would enable more of the optical path to be within the test region. The same applies to those of the monitoring receiver 310 which are coupled to the drop wavelength optical paths 320.

FIG. 9, Application to Demultiplexing for Distribution, Without Remultiplexing.

FIG. 9 shows an application in which individual wavelengths are demultiplexed and sent along separate fibers to remote equipment, 350. This could be for the purpose of cable TV distribution to domestic homes, or part of a high capacity data network within an office building, or campus for example. In this case, if the wavelength allocations are fixed, for each remote equipment, then there is no need for a PXC. Alternatively, if it is desired to make the wavelength allocations reconfigurable, then a PXC could be located down stream of the demultiplexer 100, within the head end equipment 360. The monitoring signal is input to the demultiplexer from a tuneable source 370, as described above, and detected by a monitoring receiver 380, located either in the remote equipment, or (not illustrated) alternatively, anywhere along the optical path to the head end equipment, even within the head end equipment itself.

Particularly where the distribution is to different customers, or involves sensitive or valuable data, it may be important to be able to verify the optical path, or other characteristics of the optical path. If the monitoring receiver is in the remote equipment, it may store results locally, or feed them back to the head end equipment, or other network management function, via a separate low capacity link (not illustrated), as appropriate for the application. Although illustrated using a tuneable source, of course it would be possible to use a tuneable receiver, though this is likely to be more expensive if many monitoring receivers are required. Although shown with the monitoring signal path in the same direction as the data path, of course it can be implemented in the reverse direction, with the source in the remote equipment, and a tuneable receiver in the head end equipment. In this case, it might be possible to avoid the need for a separate monitoring channel to the remote equipment, if the monitoring source in the remote equipment could be permanently on, and the tuneable receiver in the head end equipment arranged to scan the wavelengths and produce results without reference to the state of the monitoring source in the remote equipment.

Although FIG. 9 shows an application for distribution of data from a WDM input signal, of course the same considerations apply to data flowing in the reverse direction, where it is concentrated from remote equipment, to a multiplexer in the head end equipment, which outputs a WDM signal for onward transmission. This has not been illustrated, for the sake of clarity, though clearly the invention is equally applicable to such an application.

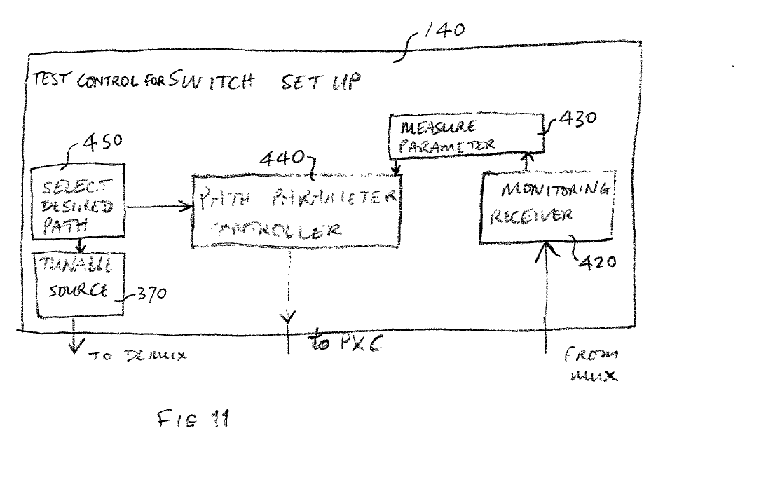

FIG. 10, Embodiment in which the Monitoring Signal Shares the Same Path as the WDM Data Signal

FIG. 10 shows a further possible implementation of the switching arrangement 10 of FIG. 1. In this case, there is no separate monitoring signal input to the demultiplexer 390 and no separate monitoring signal output on the multiplexer 400. The PXC 110 is not affected. As the monitoring signal shares the same path as the WDM signal, at the input to the demultiplexer, and the output of the multiplexer, some measure must be taken to avoid interference with the WDM data signal. One possibility is to separate them in the time domain, i.e. only use this for testing when the data signal is not present, e.g. at initial set up, or when the WDM data signal has been protection switched to an alternative route avoiding the given demultiplexer and multiplexer. Alternatively, the monitoring signal may be very low amplitude, or at frequencies not present in the data signal, to avoid interference. This could be achieved using a distinctive dither as discussed above in relation to U.S. Pat. No. 6,005,695.

The test control circuitry 410 could be similar to that shown in FIG. 4 or FIG. 5, but adapted to whichever scheme is chosen for avoiding interference. This could be achieved following conventional design principles, and therefore more details for each of the options need not be described here.

FIG. 11, Additional Features of the Test Control Part 140, for Switch Set Up

FIG. 11 shows additional or alternative features for the test control part, to enable the monitoring signal to be used for active feedback to enable the optical path to be set up. Various parameters of the optical path through the switching arrangement may be controlled. Examples include dispersion, polarisation dependent loss, gain or attenuation, and for a mirror based optical switch, mirror alignment. Many others are conceivable, though where the parameter is wavelength sensitive, then it may be difficult to measure using the monitoring signal at least for the embodiments where the monitoring signal uses a different wavelength to the data on a given wavelength channel optical path.

As shown in FIG. 11, the monitoring receiver 420 passes the monitoring signal to an appropriate parameter measuring element 430. There may be multiple such elements, for measuring different parameters. The monitoring receiver may need to be a high bandwidth high quality part, to avoid distorting the parameters being measured. The resulting measurement may be passed as a feedback signal to a path parameter controller 440. Again, there may be a number of different controllers for different parameters. For example, a mirror alignment controller may be provided for fine control of the alignment of mirrors, to minimise optical loss, based on feedback using the monitoring signal. Where there are alignment controllers for each mirror, some co-ordination is necessary to ensure the signal level for the desired path is fed to the appropriate path parameter controller. This is illustrated in FIG. 11 by the element 450, for selecting the desired path, which is coupled to the tuneable source 370.

The path parameter controller and the element for selecting the desired path may be implemented in conventional hardware such as a microcontroller, or other programmable logic, to suit the desired speed and complexity of operation.

The path parameter controller could also control the route of the optical path within the switching element, for example to trigger protection switching onto a redundant protection path to avoid a failed path such as a broken switch element such as a faulty movable mirror.

Other Remarks

Above there has been described a wavelength demultiplexer for demultiplexing optical signals carrying data, which is also used to route a separate monitoring signal on to any of the demultiplexed output paths, by changing the wavelength of the monitoring signal. This enables optical paths through a switching arrangement to be verified or tested. A multiplexer at the output of the switching arrangement may be used to detect which of the output paths of the switching element has the monitoring signal. This saves the need for individual couplers to couple a monitoring signal on to each of the inputs, and off each of the outputs of the switching element. The saving in terms of component count, cost, and reduced size increases as the number of channels increases.

Although embodiments have been described showing photonic switches, the advantages of the invention are clearly applicable to other types of switching element, including optical patch panels. Clearly the invention is equally applicable to switch elements capable of multicasting. It is quite conceivable for the demultiplexer or multiplexer to be located remotely from other parts of the switching arrangement.

Other variations will be apparent to a skilled person which also lie within the scope of the claims.

1. A switching arrangement for optical communications networks, the arrangement having;
a wavelength demultiplexer for demultiplexing wavelength multiplexed input data signals,
a switching element for defining optical paths for the demultiplexed data signals,
a multiplexer for wavelength multiplexing the demultiplexed data signals output from the switching element, and
test apparatus for sending one or more monitoring signals each of a selected wavelength, through the switching element, using the demultiplexer or the multiplexer to route each of the monitoring signals along a desired one of the optical paths through the switching element, according to the wavelength of each monitoring signal, the test apparatus further arranged to detect each monitoring signal after it has passed along the desired optical path.

2. The switching arrangement of claim 1, arranged to route the monitoring signal along the desired one of the optical paths at the same time as the demultiplexed data signals are passing through the switching element.

3. The switching arrangement of claim 1, the test apparatus being arranged to select the wavelength of the monitoring signal to be offset from a wavelength of the demultiplexed data signal on the desired optical path, to enable both signals to be present simultaneously on the desired optical path.

4. The switching arrangement of claim 1, the demultiplexer having a monitoring signal path spatially separated from an input path for the multiplexed data signal.

5. The switching arrangement of claim 3, the demultiplexer having a monitoring signal path spatially separated from an input path for the multiplexed data signal, the demultiplexer further having a shuffle property that for a given wavelength of an input signal, a spatial shift to a different input path for that signal can cause a corresponding spatial shift of an output path of that signal, the shuffle property being used to enable the demultiplexer to route the monitoring signal between the desired optical path and the spatially separated monitoring signal path, and to route simultaneously the demultiplexed data signal onto the same desired optical path from the input path for the multiplexed data signal.

6. The switching arrangement of claim 5, the demultiplexer comprising an arrayed waveguide device.

7. The switching arrangement of claim 1, the multiplexer having a monitoring signal path spatially separated from an output path for the multiplexed data signal.

8. The switching arrangement of claim 1, the multiplexer having a monitoring signal path spatially separated from an output path for the multiplexed data signal, and the multiplexer further having a shuffle property that for a given wavelength of an input signal, a spatial shift to a different input path for that signal can cause a corresponding spatial shift of an output path of that signal, the shuffle property being used to enable the multiplexer to route the monitoring signal between the desired optical path and the spatially separated monitoring signal path, and to route simultaneously one of the demultiplexed data signals from the same desired optical path onto the output path for the multiplexed data signal.

9. The switching arrangement of claim 8, the multiplexer comprising an arrayed waveguide device.

10. The switching arrangement of claim 1 arranged to use both the demultiplexer and the multiplexer for routing the monitoring signal.

11. The switching arrangement of claim 1, the test apparatus being arranged to select the wavelength of the monitoring signal within a band of wavelengths used by the multiplexed data signal.

12. The switching arrangement of claim 1, the test apparatus having a apparatus for controlling the wavelength of the monitoring signal to control which of the optical paths is being monitored.

13. The switching arrangement of claim 1., the test apparatus being arranged to send a plurality of monitoring signals of different wavelengths simultaneously, and having a tuneable receiver for distinguishing between the monitoring signals.

14. The switching arrangement of claim 1, the test apparatus having circuitry for determining which monitoring signal wavelength to use to cause the monitoring signal to pass along the desired optical path.

15. The switching arrangement of claim 1, the test apparatus having circuitry for controlling the wavelength of the monitoring signal, coupled to circuitry for detecting the monitoring signal, the test apparatus being arranged to determine which wavelengths have been detected.

16. The switching arrangement of claim 1, the test apparatus being arranged to send the monitoring signal on one optical path, and detect from another optical path.

17. The switching arrangement of claim 1, the demultiplexers having output paths and the multiplexers having input paths, each for use by demultiplexed data signals of a corresponding wavelength, the switching element having a number of wavelength planes, each plane arranged to switch the demultiplexed data signals of a single wavelength between the input paths and output paths corresponding to that wavelength.

18. The switching arrangement of claim 1, the test apparatus further comprising optical path parameter measurement circuitry, for measuring a parameter of the optical path passed by the detected monitoring signal, and optical path parameter control circuitry, for controlling the optical path parameter according to an output of the measurement circuitry.

19. A node for an optical network having the switching arrangement of claim 1, and optical amplifiers for transmitting the multiplexed data signal to other nodes.

20. A wavelength adding node for a wavelength division multiplexed optical network, the node having the switching arrangement set out in claim 1, the switching element having at least one wavelength add input path not passing through the demultiplexer, the test apparatus being coupled to send and detect monitoring signals along the add input path.

21. A wavelength dropping node for a wavelength division multiplexed optical network, the node having the switching arrangement of claim 1, the switching element having at least one wavelength drop output path not passing through the multiplexer, the test apparatus being coupled to send and detect monitoring signals along the drop output path.

22. A wavelength adding node for a wavelength division multiplexed optical network, the node having the switching arrangement of claim 2, the switching element having at least one wavelength add input path not passing through the demultiplexer, the test apparatus being coupled to send and detect monitoring signals along the add input path.

23. A wavelength dropping node for a wavelength division multiplexed optical network, the node having the switching arrangement of claim 2, the switching element having at least one wavelength drop output path not passing through the multiplexer, the test apparatus being coupled to send and detect monitoring signals along the drop output path.

24. Demultiplexing apparatus having a wavelength demultiplexer for demultiplexing optical wavelength multiplexed input data signals onto a number of output optical paths, and a tunable source, for outputting at a selected optical wavelength a monitoring signal to the demultiplexer, on a separate path from the multiplexed input data signals, the demultiplexer being arranged to route the monitoring signal onto a selected one of the output optical paths according to the wavelength of the monitoring signal, for detection downstream along the optical paths.

25. Multiplexing apparatus having a wavelength multiplexer for optical wavelength multiplexing a number of input data signals on a number of input optical paths, and a receiver, for receiving at a selected optical wavelength a monitoring signal, the multiplexer being arranged to route the monitoring signal to the receiver, from a selected one of the output optical paths according to the wavelength of the monitoring signal, and on a separate path to the multiplexed output data signals.

26. Test apparatus for a switching arrangement for optical communications networks, the arrangement having a wavelength demultiplexer for demultiplexing wavelength multiplexed input data signals, a switching element for defining optical paths for the demultiplexed data signals, and a multiplexer for wavelength multiplexing the demultiplexed data signals output from the switching element, the test apparatus having
circuitry for sending a monitoring signal of a selected wavelength through the switching element, using the demultiplexer or the multiplexer to route the monitoring signal along a desired one of the optical paths through the switching element, according to the wavelength of the monitoring signal, and
circuitry arranged to detect the monitoring signal after it has passed along the desired optical path.

27. The test apparatus of claim 26, the test apparatus further comprising optical path parameter measurement circuitry, for measuring a parameter of the optical path passed by the detected monitoring signal.

28. A network management system for use with nodes of an optical communications network, at least one of the nodes having a switching arrangement as set out in claim 1, the network management system having software for indicating to the test apparatus of the switching arrangement which optical path to monitor, and software for receiving monitoring results from the test apparatus.

29. A method of using a demultiplexer for routing a monitoring signal, the demultiplexer being arranged to demultiplex optical wavelength multiplexed input data signals onto a number of output optical paths, the demultiplexer having a separate input for a monitoring signal, the method comprising the step of inputting the monitoring signal at a wavelength selected such that the demultiplexer routes the monitoring signal onto a desired one of the output paths according to the wavelength of the monitoring signal, for detection downstream along the optical paths.
